(19) United States
(12) Patent Application Publication
(10) Pub. No.: US 2024/0043684 A1
(43) Pub. Date: Feb. 8, 2024

(54) THERMOPLASTIC COMPOSITION WITH GOOD PLATING PERFORMANCE

(71) Applicant: SABIC Global Technologies B.V., Bergen op Zoom (NL)

(72) Inventors: Vikram K. Daga, Evansville, IN (US); Jeffrey Eshenaur, Hamilton, MI (US)

(21) Appl. No.: 18/266,356

(22) PCT Filed: Dec. 7, 2021
(86) PCT No.: PCT/EP2021/084636

§ 371 Date: Jun. 9, 2023

(30) Foreign Application Priority Data
Dec. 11, 2020 (EP) 20213546.3

(51) Int. Cl. C08L 69/00; C23C 18/22; C25D 5/56

(52) U.S. Cl. CPC C08L 69/00; C23C 18/22; C25D 5/56; C08L 2205/025; C08L 2205/035

(57) ABSTRACT

The present invention relates to a thermoplastic composition comprising (A) from 30 to 80 wt. % of aromatic polycarbonate, (B) from 10 to 35 wt. % of impact modifier, (C) from 10 to 35 wt. % of flow enhancing copolymer composition, (D) from 0 to 10 wt. % of further components wherein the combined weight of components (A), (B), (C) and (D) equals to 100 wt. % and the wt. % is based on the weight of the composition, the impact modifier comprises a copolymer of a conjugated diene elastomer wherein the amount of diene elastomer is at least 50 wt. %, based on the weight of the copolymer, the flow enhancing copolymer composition consists of (i) from 0 to 90 wt. % of first aromatic vinyl copolymer and (ii) from 100 to 10 wt. % of second aromatic vinyl copolymer having a Tg that is higher than the Tg of said first aromatic vinyl copolymer.

The present invention relates to a thermoplastic composition suitable for the manufacture of substrates for plating applications, such as electroplating applications or electroless plating applications. Plating of substrates is done for different reasons including aesthetics as well as to protect the polymer material from wear and degradation over time. For example plated articles can be found in the automotive sector where typical parts that undergo plating may be wheel-covers, door-handles, grilles, tail lamp bezels and OEM logos. The use of plating can however also be found in other industries like for example electronics, appliances, toys, furniture and the like. Methods for electroplating and electroless plating, generally and unless indicated otherwise referred to herein as plating, are well known to a skilled person. The present invention is in particular related to the compositions for the manufacture of substrates for electroplating.

Typical materials used for plating are acrylonitrile-butadiene-styrene (ABS) copolymers or blends of ABS with other polymers, such as polycarbonate (PC). Such blends are typically referred to as PC/ABS. On the other hand and more generally, polycarbonate blends comprising polycarbonate and a conjugated diene elastomer generally may be suitable for plating and are not limited to PC/ABS. To that extent the composition of the materials varies and may be tuned to accommodate the intended application. In general, desirable properties for substrate resins include peel strength, melt flow, tensile strength, heat deflection temperature (HDT), tensile strength, and impact properties.

WO 2013/115903 discloses a thermoplastic composition with improved electroplate adhesion comprising from about 40 wt. % to about 75 wt. % of one or more polycarbonate resins, from about 24 wt. % to about 53 wt. % of a first impact modifier, and from about 1 wt. % to about 7 wt. % of a second impact modifier; wherein the composition exhibits an adhesion value at least about 10% greater than that of a reference composition consisting essentially of substantially the same proportions of the same polycarbonate polymer and the same first impact modifier.

WO 2016/103160 discloses platable resin compositions for use in, for example, metal plating of plastics. The resin compositions include polycarbonate, acrylonitrile butadiene styrene and a filler, and may exclude a laser direct structuring additive. The compositions possess markedly improved characteristics, such as notched Izod impact, flexural modulus, and peel strength. Methods for plating metal on a substrate that is formed from such resin compositions, as well as articles that include the compositions are also disclosed.

U.S. Pat. No. 4,847,153 discloses a composition which comprises (i) 20 to 95 phr of an aromatic polycarbonate, (ii) 2 to 20 phr of an impact modifier which contains at least 45% of an elastomeric phase of a conjugated diene polymer having a glass transition temperature below 20° C., and optionally a grafted phase consisting essentially of either methacrylate and styrene or acrylonitrile and styrene grafts (iii) 3 to 78 phr of a conjugated diene graft polymer having a rubbery backbone and a grafted phase which is characterized in that said backbone is about 1-40% relative to its weight and in that its grafted phase comprises the polymerized mixture of monovinyl aromatic monomers and α-alkyl substituted monovinyl aromatic monomers at a ratio therebetween of from about 30:1 to 1:30. A metal plated article obtained by the electroless plating of a moulded part comprising this composition is also disclosed. According to this patent the use of α-alkyl substituted monovinyl aromatic monomers allows the composition to have a higher heat deflection temperature (HDT).

US 2009/0226727 discloses a resin composition for direct plating, which is a thermoplastic resin composition containing a rubber-reinforced vinyl-based resin, being characterized in that said rubber reinforced vinyl-based resin comprises a diene-based rubbery polymer [a1] and an ethylene α-olefin-based rubbery polymer [a2], that the total amount of said diene-based rubbery polymer [a1] and said ethylene α-olefin-based rubbery polymer [a2] is in a range from 3 to 30% by mass based on said thermoplastic resin composition, and that the ratio of said ethylene α-olefin-based rubbery polymer [a2] to said total amount is in a range from 0.01 to 0.4.

CN106633769 discloses the following components and parts by weight: 30 to 60 portions of PC resin, 20 to 50 portions of ABS high powder and 15-35 parts of α-SAN resin, 1 to 5 parts of compatibilizing agent, 0.1 to 1 part of antioxidant and 0.1 to 1 part of lubricant. The α-SAN resin disclosed in this reference are α-methyl-styrene-styrene-acrylonitrile polymers having a heat distortion temperature of 100˜110° C. This reference does not disclose copolymers of α-methyl-styrene and acrylonitrile, i.e. α-methyl-styrene-acrylonitrile copolymers.

U.S. Pat. No. 3,491,071 discloses a process for producing copolymers of acrylonitrile, styrene and alpha-methylstyrene wherein a mixture of these monomers is polymerized in the presence of a catalyst and an aqueous suspension at a temperature gradually raised from about 100 to about 140° C. until the degree of conversion of the monomer to the polymers is about 90 to 98% and then steam-distilling the mass to remove unreacted monomers when the temperature reaches about 140° C. and this conversion is attained to produce a product of high stampability and freedom from yellowing. Copolymers of three monomers are generally referred to as terpolymers.

U.S. Pat. No. 10,170,214 discloses a thermoplastic resin composition, comprising 10 to 35 wt % of a first graft copolymer resin in which 55 to 65 parts by weight of a diene-based rubber polymer and 35 to 45 parts by weight of a monomer mixture, in which an aromatic vinyl monomer and a vinyl cyanide monomer are mixed in a weight ratio of 60 to 80:20 to 40 respectively, are graft-polymerized; 1 to 12 wt % of a second graft copolymer resin in which 45 to 55 parts by weight of a diene-based rubber polymer and 45 to 55 parts by weight of a monomer mixture, in which an aromatic vinyl monomer and a vinyl cyanide monomer are mixed in a weight ratio of 60 to 80:20 to 40 respectively, are graft-polymerized; 10 to 30 wt % of a first copolymer resin in which an aromatic vinyl monomer and a vinyl cyanide monomer are copolymerized in a weight ratio of 60 to 80:20 to 40 respectively; 30 to 75 wt % of a polycarbonate resin; and 2 to 8 wt % of a conductive filler.

US 2019/0352499 discloses a thermoplastic resin composition comprising (A) a polycarbonate resin; (B) an aromatic vinyl compound-vinyl cyanide compound copolymer with a vinyl cyanide compound content of 32 wt % to 35 wt %; (C-1) a first acrylonitrile-butadiene-styrene graft copolymer with an average particle diameter of a rubber polymer of 200 nm to 350 nm; (C-2) an acrylonitrile-butadiene-styrene copolymer comprising a second acrylonitrile-butadiene-styrene graft copolymer with an average particle diameter of a rubber polymer of 400 nm to 600 nm; (D) a polybutylene terephthalate resin; and (E) a compatibilizer.

The properties of a plated substrate depend inter alia on the composition of the substrate itself, the plating process, the plating layer and the interaction between the plating layer and the substrate. It is desired that the plating layer adheres well to the substrate and does not generate delamination and/or blister formation during typical tests or under typical use conditions. It is further desired that plated articles on the basis of polycarbonate and an impact modifier such as acrylontrile-butadiene-styrene copolymers have a good heat stability, which typically translates into a high heat deflection temperature (HDT).

It is an object of the present invention to provide for a thermoplastic composition combining good platability and improved heat stability.

More in particular it is an object of the present invention to provide for a thermoplastic composition that allows the manufacture of plated substrates with one or more, or preferably the combination of good mechanical properties, good heat stability, good adhesion and appearance of the plating layer.

To that extent the present invention relates to a thermoplastic composition comprising or consisting of,
(A) from 30 to 80 wt. %, preferably 30 to 70 wt. % of aromatic polycarbonate,
(B) from 10 to 35 wt. %, preferably 15-35 wt. % of impact modifier,
(C) from 10 to 35 wt. %, preferably 15-35 wt. % of flow enhancing copolymer composition,
(D) from 0 to 10 wt. % of further components
   wherein,
the combined weight of components (A), (B), (C) and (D) equals to 100 wt. % and the wt. % is based on the weight of the composition,
the impact modifier comprises a copolymer of a conjugated diene elastomer wherein the amount of diene elastomer is at least 50 wt. %, based on the weight of the copolymer,
the flow enhancing copolymer composition consists of (i) from 0 to 90 wt. % of first aromatic vinyl copolymer and (ii) from 100 to 10 wt. % of second aromatic vinyl copolymer having a Tg that is higher than the Tg of said first aromatic vinyl copolymer.

For the avoidance of doubt it is to be understood that the term “aromatic vinyl copolymer” is a copolymer obtained by (co)polymerisation of a vinyl monomer comprising at least one aromatic group.

The Tg of the second aromatic vinyl copolymer is preferably at least 8° C., more preferably at least 10° C. even more preferably at least 12° C. higher than the Tg of the first vinyl copolymer. The difference in Tg may vary depending on the actual materials being used but preferably the difference between the Tg of the first and second aromatic vinyl copolymers may be at most 35° C., at most 25° C., at most 20° C. or at most 18° C.

The first and second vinyl copolymers preferably are copolymers which differ in at least one monomer.

Preferably the present invention relates to a thermoplastic composition comprising or consisting of
(A) from 30 to 80 wt. %, preferably 30 to 70 wt. % of aromatic polycarbonate,
(B) from 10 to 35 wt. %, preferably 15-35 wt. % of impact modifier,
(C) from 10 to 35 wt. %, preferably 15-35 wt. % of flow enhancing copolymer composition,
(D) from 0 to 10 wt. % of further components
   wherein,
the combined weight of components (A), (B), (C) and (D) equals to 100 wt. % and the wt. % is based on the weight of the composition,
the impact modifier comprises a copolymer of a conjugated diene elastomer wherein the amount of elastomer is at least 50 wt. %, based on the weight of the copolymer,
the flow enhancing copolymer composition consists of (i) from 0 to 90 wt. % of styrene acrylonitrile copolymer and (ii) from 100 to 10 wt. % of a copolymer of α-methyl-styrene, acrylonitrile and optionally styrene, or the flow enhancing copolymer composition consists of a copolymer of styrene, α-methyl-styrene, and acrylonitrile.

Preferably the present invention relates to a thermoplastic composition comprising or consisting of
(A) from 30 to 80 wt. %, preferably 30 to 70 wt. % of aromatic polycarbonate,
(B) from 10 to 35 wt. %, preferably 15-35 wt. % of impact modifier,
(C) from 10 to 35 wt. %, preferably 15-35 wt. % of flow enhancing copolymer composition,
(D) from 0 to 10 wt. % of further components
   wherein,
the combined weight of components (A), (B), (C) and (D) equals to 100 wt. % and the wt. % is based on the weight of the composition,
the impact modifier comprises a copolymer of butadiene and at least one selected from styrene, acrylonitrile and methyl methacrylate wherein the amount of butadiene is at least 50 wt. %, based on the weight of the copolymer,
the flow enhancing copolymer composition consists of (i) from 0 to 90 wt. % of styrene acrylonitrile copolymer and (ii) from 100 to 10 wt. % of a copolymer of α-methyl-styrene, acrylonitrile and optionally styrene or the flow enhancing copolymer composition consists of a copolymer of styrene, α-methyl-styrene, and acrylonitrile.

Preferably the present invention relates to a thermoplastic composition comprising or consisting of
(A) from 30 to 80 wt. %, preferably 30 to 70 wt. % of aromatic polycarbonate,
(B) from 10 to 35 wt. %, preferably 15-35 wt. % of impact modifier,
(C) from 10 to 35 wt. %, preferably 15-35 wt. % of flow enhancing copolymer composition,
(D) from 0 to 10 wt. % of further components
   wherein,
the combined weight of components (A), (B), (C) and (D) equals to 100 wt. % and the wt. % is based on the weight of the composition,
the impact modifier comprises, essentially consists of or consists of a copolymer of butadiene, acrylonitrile and styrene wherein the amount of butadiene is at least 50 wt. %, based on the weight of the copolymer,
the flow enhancing copolymer composition consists of (i) from 0 to 90 wt. % of styrene acrylonitrile copolymer and (ii) from 100 to 10 wt. % of a copolymer of α-methyl-styrene, acrylonitrile and optionally styrene or the flow enhancing copolymer composition consists of a copolymer of styrene, α-methyl-styrene, and acrylonitrile.

With respect to the components (A)-(D) the foregoing compositions either in their broadest formulations or in their preferred variations are presented herein to comprise or consist consisting of
(A) from 30 to 80 wt. %, preferably 30 to 70 wt. % of aromatic polycarbonate,
(B) from 10 to 35 wt. %, preferably 15-35 wt. % of impact modifier,
(C) from 10 to 35 wt. %, preferably 15-35 wt. % of flow enhancing copolymer composition,
(D) from 0 to 10 wt. % of further components.

These compositions however are also disclosed, with respect to the components (A)-(D) herein to comprise or consist of
(A) from 30 to 80 wt. %, preferably 30 to 70 wt. % of aromatic polycarbonate,
(B) from 15-35 wt. % of impact modifier,
(C) from 15-35 wt. % of flow enhancing copolymer composition,
(D) from 0 to 10 wt. % of further components.

### Polycarbonate

The polycarbonate in the composition of the present invention is not limited and may be any aromatic polycarbonate. The polycarbonate is preferably an aromatic polycarbonate comprising bisphenol A, also known as 2,2-bis(4-hydroxyphenyl)propane, structural units. Thus the aromatic polycarbonate may be a homopolymer of bisphenol A or a copolymer comprising bisphenol A and one or more further bisphenols. The polycarbonate can also be a polycarbonate polyester copolymer.

Methods for the manufacture of polycarbonate are known to the skilled person and include the interfacial process and the melt process in particular.

In the interfacial process bisphenol A, and optionally comonomers, are reacted in solution with a carbonate source which is typically phosgene. During the process an amount of endcapping agent such as for example phenol or para-cumyl phenol is added in order to stop the chain growth and hence to control the molecular weight. Generally, interfacial polycarbonate will therefore have a negligible amount of terminal OH groups originating from the bisphenol.

In the melt process bisphenol A, and optionally comonomers, are reacted in molten state with a carbonate source, which is typically a diarylcarbonate such as diphenyl carbonate. The transesterification reaction results in the formation of phenol byproduct which is withdrawn from the reactors in order to drive the reaction and hence to increase the molecular weight. In a typical melt process no end capping agents are added to the reactors so that the resulting polycarbonate has, compared to interfacial polycarbonate, a much higher amount of terminal hydroxy groups. Apart from that, the melt process also results in a certain amount of branching, which is known as Fries branching. The amount of Fries branching is typically at most 2000 ppm, preferably at most 1500, more preferably at most 1200 ppm. The term Fries branching is known to the skilled person and refers inter alia to the structures as disclosed in EP2174970.

The polycarbonate of the present invention is preferably a bisphenol A polycarbonate homopolymer. The polycarbonate may be a polycarbonate manufactured with the interfacial process, i.e. the polycarbonate may be an interfacial polycarbonate. Alternatively the polycarbonate may be a melt polycarbonate, i.e. a polycarbonate manufactured with the melt process.

The polycarbonate in the composition of the invention may be a single polycarbonate or it may be a mixture of two or more different polycarbonates. Such a mixture may be a mixture of homopolymers or copolymers or homopolymers and copolymers. Any one or more of the polycarbonates of such a mixture may be manufactured with a melt process or an interfacial process. It is preferred that the polycarbonate is a mixture of a first (bisphenol A) polycarbonate homopolymer having a weight average molecular weight of from 17,000 to less than 25,000 g/mol and a second (bisphenol A) polycarbonate homopolymer having a weight average molecular weight of from 25,000 to 35,000 g/mol.

The polycarbonate preferably has a weight average molecular weight, determined with GPC using polycarbonate standards of from 15.000 to 35,000 g/mol, preferably from 20.000 to 30.000 g/mol. For the avoidance of doubt it is noted that the polycarbonate may be a mixture of two or more polycarbonates in which case the weight average molecular weight is determined on said mixture and accordingly an average of the molecular weights of the respective polycarbonates. It is noted that the weight average molecular weight of the individual polycarbonates may be outside of this range and may generally be from 15,000 to 40,000 g/mol, provided that the mixture of polycarbonates meets the aforementioned range of from 15.000 to 35,000 g/mol and preferably from 22,000 to 30,000 g/mol.

The amount of polycarbonate in the composition may be from 30-60 wt. %, preferably from 35-55 wt. %, more preferably from 35-50 wt. %. Higher contents of polycarbonate may be favourable for thermal stability, i.e. good heat deflection temperature, but compositions with higher polycarbonate content may also be more difficult to undergo plating and/or require a specific pre-treatment step.

### Impact Modifier

The impact modifier in the composition of the invention comprises a copolymer of a conjugated diene elastomer. The diene elastomer is preferably a polybutadiene, polyisoprene, or a poly ethylene-propylene-diene, preferably polybutadiene. It is preferred that the impact modifier is a block copolymer or a graft copolymer. A block copolymer, as known to a skilled person, is a copolymer wherein blocks of different polymer types are connected. For example styrene-butadiene-styrene copolymers are known to be block copolymers composed of a polystyrene block connected to a polybutadiene block connected to another polystyrene block. A graft copolymer, as known to a skilled person, is a copolymer where a first (co)polymer is grafted onto or from a second (co)polymer. An example may be graft type acrylonitrile-styrene-butadiene copolymers where copolymers of acrylonitrile and styrene are grafted onto polybutadiene. The impact modifier may be of the core-shell type comprising a core comprising or consisting of the diene elastomer and a shell comprising or consisting of the non-elastomer block. An example may be core-shell type ABS comprising a core of polybutadiene elastomer and a shell of styrene-acrylonitrile copolymer.

The impact modifier comprises a copolymer of a conjugated diene elastomer wherein the amount of diene elastomer is at least 50 wt. %, based on the weight of the copolymer. A minimum amount of diene elastomer is relevant to the plating process because typically the diene elastomer domains in the composition are etched away prior to the actual plating layer being applied in order to improve the adhesion of the plating layer. In addition a high amount of elastomer in the impact modifier provides more flexibility with regards to the final properties of the composition. In particular a high amount of elastomer in the impact modifier allows a smaller loading of the impact modifier in the overall formulation of the composition to deliver the required rubber phase. Accordingly this helps to tune the combined impact properties, flow properties, heat stability properties and platability (i.e. the capability of the material to be plated) to a desired level.

For example, a higher amount of elastomer content allows the use of higher amount of flow enhancing copolymer composition and/or higher amount of polycarbonate resulting in a composition that combines favourable plating properties with good flow and impact strength.

The impact modifier may be a single copolymer or a mixture of copolymers. The amount of diene elastomer is at least 50 wt. % based on the amount of impact modifier.

The diene elastomer is typically a separate phase in the impact modifier and may either have a mono-modal particle size distribution or a multi-modal, such as a bi-modal, particle size distribution. The terms mono-modal and multi-modal are considered known to the skilled person. For the avoidance of doubt it is noted that a multi-modal distribution means a particle size distribution with two or more maximums or with only one maximum yet with a distinct shoulder in the curve representing the particle size distribution. In case of a multimodal distribution a distribution with two maximums is preferred.

It is further preferred that the amount of copolymer is comprised in the impact modifier in an amount of at least 75 wt. % based on the weight of the impact modifier. Preferably the amount of copolymer is comprised in the impact modifier in an amount of at least 75 wt. % based on the weight of the impact modifier and the amount of diene elastomer is preferably at least 50 wt. % based on the amount of impact modifier. More preferably the amount copolymer is at least 90 wt. %, even more preferably at least 95 wt. % based on the weight of impact modifier. Even further preferred is a composition wherein the impact modifier essentially consists or consists of copolymer(s) of a conjugated diene elastomer. The copolymer comprised in the impact modifier is preferably selected from the group consisting of styrene-butadiene-styrene (SBS), styrene-butadiene (SBR), styrene-ethylene-butadiene-styrene (SEBS), acrylonitrile-butadiene-styrene (ABS), acrylonitrile-ethylene-propylene-diene-styrene (AES), styrene-isoprene-styrene (SIS), methyl methacrylate-butadiene (MB) and methyl methacrylate-butadiene-styrene (MBS) and combinations of at least two of the foregoing copolymers.

It is more preferred that the impact modifier comprises, essentially consists or consists of ABS, MB or MBS with ABS being most preferred. An amount of one or more of these preferred impact modifiers of at least 90 wt. %, such as 95 wt. % or 98 wt. % based on the weight of impact modifier is preferred.

Acrylonitrile butadiene styrene copolymers are available as so called bulk ABS and graft ABS. In the context of the present invention the ABS is preferably graft type ABS. Accordingly and in an aspect of the invention the composition does not contain bulk ABS.

Graft ABS is obtained by first polymerising a butadiene so as to form a butadiene latex containing butadiene elastomer particles followed by the grafting of styrene-acrylonitrile copolymer (SAN) grafts onto said elastomer particles. The process to manufacture graft ABS may result in styrene-acrylonitrile copolymers grafted onto the polybutadiene elastomer particles and in addition to that some non-bound, or free, styrene acrylonitrile polymer. For the purpose of the present invention the free SAN is considered to be contained in the impact modifier and not as a separate component. In view of the nature of the process graft ABS typically has a core-shell structure comprising a core containing the polybutadiene elastomer and a shell containing the styrene acrylonitrile copolymer. Bulk ABS, as known by a skilled person, differs in morphology from graft ABS and typically bulk ABS does not contain an amount of polybutadiene exceeding 50 wt. %, contrary to the requirements of the present invention. Notwithstanding the foregoing the present invention does not exclude mixtures of high diene elastomer content impact modifiers and low diene elastomer content impact modifiers as long as the requirement for the minimum amount of diene elastomer is met.

It is preferred that the impact modifier contains (graft) ABS and MBS for the reason that an amount of MBS provides the composition with an improved low temperature ductility.

It is also preferred that the ABS is graft ABS and the composition may be free from bulk ABS. Provided the amount of

An amount of impact modifier of from 20-30 wt. % may be preferred.

### Flow Enhancing Copolymer Composition

The flow enhancing copolymer composition in the thermoplastic composition disclosed herein consists of (i) from 0 to 90 wt. % of first aromatic vinyl copolymer and (ii) from 100 to 10 wt. % of second aromatic vinyl copolymer having a Tg that is higher than the Tg of said first aromatic vinyl copolymer. For the avoidance of doubt its is noted that the flow enhancing composition preferably contains the first and second aromatic vinyl copolymer.

It is preferred that the flow enhancing copolymer composition in the thermoplastic composition disclosed herein consists of (i) from 1 to 90 wt. %, 10-80 wt. %, 25-75 wt. % or 40-60 wt. % of first aromatic vinyl copolymer and (ii) from 99 to 10 wt. %, 80-10 wt. %. 75-25 wt. %, 60-40 wt. % of second aromatic vinyl copolymer having a Tg that is higher than the Tg of said first aromatic vinyl copolymer. A flow enhancing composition consisting (i) from 40-60 wt. % of first aromatic vinyl copolymer and (ii) from 60-40 wt. % of second aromatic vinyl copolymer is particularly preferred.

The term “flow enhancing copolymer composition” in the context of the present invention is to be understood as a composition that enhances the flow of an otherwise identical composition that does not contain the flow enhancing copolymer composition. Thus, a composition that consists of (i) from 0 to 90 wt. % of first aromatic vinyl copolymer and (ii) from 100 to 10 wt. % of second aromatic vinyl copolymer having a Tg that is higher than the Tg of said first aromatic vinyl copolymer, yet which does not enhance the flow of the base composition to which it is added is not considered as a “flow enhancing composition” in the context of the present invention. Preferably the flow enhancing composition enhances the melt flow rate of the composition not containing the flow enhancing composition with at least 2%, preferably at least 5%, more preferably at least 10%, with the melt flow rate being determined in accordance with ASTM D1238 at 260° C. and 5 kg.

Preferably the flow enhancing copolymer composition is a monophasic, or single-phase, composition, i.e. the components (i) and (ii) form a homogeneous mixture. The flow enhancing copolymer composition may be at least partially compatible with the aromatic polycarbonate and may form a stable mixture therewith. Alternatively or in addition the flow enhancing copolymer composition may be at least partially compatible with the impact modifier and may form a stable mixture therewith. In that respect a stable mixture is to be understood as a (partially) monophasic mixture or a heterophasic mixture wherein the two (or more) phases do not delaminate from one another.

Measurement of a glass transition temperature, Tg, is well known to the skilled person and generally determined from a differential scanning calorimetry (DSC) measurement. By way of example the Tg can be measured using DSC with a heat cycle from 40° C. to 180° C. at a rate of 10° C./min and wherein the Tg was determined in the second cycle.

### First Aromatic Vinyl Copolymer

The first aromatic vinyl copolymer is preferably a copolymer of
styrene, α-substituted styrene, ring-substituted styrene or a mixture thereof and
acrylonitrile, methacrylonitrile or a mixture thereof.

Even more preferably the first aromatic vinyl copolymer is a copolymer of styrene and acrylonitrile. The first aromatic vinyl copolymer is preferably not a terpolymer, i.e. a polymer of three (or more) monomers.

The amount of styrene, α-substituted styrene, ring-substituted styrene, or a mixture thereof may be from 50 to 95 wt. %, preferably from 65 to 85 wt. % based on the weight of the first aromatic vinyl copolymer. The α-substituted styrene is preferably α-methyl styrene.

The amount of acrylonitrile, methacrylonitrile or a mixture thereof may be from 50 to 5 wt. %, preferably from 35 to 15 wt. % based on the weight of the first aromatic vinyl copolymer.

The α-substituted styrene, if any, is preferably selected from one or more of α-methyl styrene, α-ethyl styrene, α-propyl styrene or α-butyl styrene. Most preferably the α-substituted styrene is α-methyl styrene. The first aromatic vinyl copolymer may not contain α-substituted styrene.

The melt flow rate of the first aromatic vinyl copolymer may be from 1-50 g/10 min as determined in accordance with ISO 1133 (230° C., 1.2 kg). Preferably the melt flow rate may be from 2-40, 2-25 or 3-20 or 4-10 g/10 min. The same ranges apply for any more specifically defined first aromatic vinyl copolymer.

### Second Aromatic Vinyl Copolymer

The second aromatic vinyl copolymer preferably is a copolymer of
α-substituted styrene or a mixture of styrene and α-substituted styrene and
acrylonitrile, methacrylonitrile or a mixture thereof.

Even more preferably the second aromatic vinyl copolymer is a copolymer of α-substituted styrene or a mixture of α-substituted styrene and styrene, and acrylonitrile. Most preferably the second aromatic vinyl copolymer is a copolymer of α-substituted styrene, such as α-methyl styrene and acrylonitrile.

The amount of styrene, α-substituted styrene, ring-substituted styrene or a mixture thereof may be from 50 to 95 wt. %, preferably from 65 to 85 wt. % based on the weight of the second aromatic vinyl copolymer. Thus, the amount of α-substituted styrene and optional styrene may be from 50 to 95 wt. %, preferably from 65 to 85 wt. % based on the weight of the second aromatic vinyl copolymer. The α-substituted styrene is preferably α-methyl styrene.

The amount of acrylonitrile, methacrylonitrile or mixture thereof may be from 50 to 5 wt. %, preferably from 35 to 15 wt. % based on the weight of the second aromatic vinyl copolymer.

The α-substituted styrene is preferably selected from one or more of α-methyl styrene, α-ethyl styrene, α-propyl styrene or α-butyl styrene. Most preferably the α-substituted styrene is α-methyl styrene.

Accordingly it is preferred that the first aromatic vinyl copolymer is a copolymer of styrene and acrylonitrile and the second aromatic vinyl copolymer is a copolymer of α-substituted styrene, acrylonitrile and optionally styrene and wherein the α-substituted styrene is preferably selected from α-methyl styrene, α-ethyl styrene α-propyl styrene and α-butyl styrene, preferably α-methyl styrene. The general composition for the first and second vinyl copolymers also applies to these preferred copolymers.

If the second aromatic vinyl copolymer is a terpolymer of styrene, α-substituted styrene and acrylonitrile then preferably the amount of styrene is at most 15 wt. %, preferably at most 10 wt. % more preferably at most 5 wt. % based on the weight of the second aromatic vinyl copolymer. The α-substituted styrene is preferably α-methyl styrene.

The second aromatic vinyl copolymer is preferably not a terpolymer, i.e. a polymer of at least three monomers.

The melt flow rate of the second vinyl copolymer may be from 2-30 g/10 min as determined in accordance with ISO 1133 (230° C., 3.8 kg). Preferably the melt flow rate may be from 2-25, 3-20 or 5-15 g/10 min. The same ranges apply for any more specifically defined first aromatic vinyl copolymer.

Preferably the flow enhancing copolymer composition consists of 0 to 80 wt. %, preferably 0 to 60 wt. %, of styrene-acrylonitrile copolymer and from 100 to 20 wt. %, preferably 100 to 40 wt. % of copolymer of α-substituted-styrene, acrylonitrile and optionally styrene. The α-substituted-styrene-acrylonitrile copolymer most preferably is α-methyl-styrene-acrylonitrile copolymer.

It is preferred that the flow enhancing copolymer composition consists of (i) from 10-80 wt. %, 25-75 wt. % or 40-60 wt. % of styrene-acrylonitrile copolymer and (ii) from 80-10 wt. %. 75-25 wt. %, 60-40 wt. % of copolymer of α-substituted-styrene and acrylonitrile. A flow enhancing composition consisting (i) from 40-60 wt. % of styrene-acrylonitrile copolymer and (ii) from 60-40 wt. % of α-methyl-styrene-acrylonitrile copolymer is particularly preferred.

In an embodiment the flow enhancing copolymer composition consists of a copolymer of styrene, α-methyl styrene and acrylonitrile. Such a polymer may also be referred to as a terpolymer. In this embodiment the amount α-methyl-styrene may be from 25-75, preferably from 40-60 wt. % and the remaining balance consists of styrene acrylonitrile in a weight ratio from 0.1-10.

For the avoidance of doubt it is to be understood that where the first and second flow enhancing copolymers are both copolymers of an α-substituted-styrene and acrylonitrile that the amount of α-substituted-styrene in the second flow enhancing copolymer is higher than in the first flow enhancing copolymer such that the glass transition temperature of the second flow enhancing copolymer is higher than the glass transition temperature of the first flow enhancing copolymer.

The amount of flow enhancing copolymer composition may be from 20-30 wt. %.

### Further Components

The composition of the present invention optionally includes up to 10 wt. %, based on the weight of the composition. Further components may include colorants, fillers, reinforcing agents, stabilisers, flame retardants, anti-drip agents, mould release agents, plasticisers, lubricants and the like. The optional further components may be comprised in the thermoplastic composition in an amount of from 0 to 7 wt. %, preferably 0 to 5 wt. % such as from 1 to 7 wt. % or 2 to 5 wt. %.

In an embodiment the thermoplastic composition disclosed herein consists of the components (A) to (C) where any further components such as stabilisers, quenchers and anti-oxidants in particular originate solely from their presence in the raw materials for components (A) to (C).

The composition of the present invention preferably does not comprise a compatibiliser. More in particular the composition of the present invention preferably does not comprise from 1-5 wt. % of a compatiliser such as disclosed in CN106633769. Such a compatibiliser may be maleic anhydride grafted polystyrene, maleic anhydride grafted styrene-acrylonitrile copolymer or mixtures of thereof. The compatibilisers disclosed and/or defined in CN106633769, and which are preferably excluded from the composition of the present invention, are specifically incorporated by reference herein.

### Composition

The thermoplastic composition as disclosed herein preferably has a heat deflection temperature of at least 90° C., preferably at least 95° C. when measured in accordance with ISO 75 at 1.8 MPa on an injection moulded sample having a thickness of 4.0 mm

The amount of polycarbonate in the composition is from 30-80 wt. %, preferably from 30-70 wt. %, more preferably from 30-60 wt. %, more preferably from 35-55 wt. %. Preferably the amount of polycarbonate is from 30-50 wt. %. An advantage of a lower polycarbonate content is that the plating process requires less pre-treatment before the actual plating layer is applied.

Thus, in a preferred embodiment of the invention the composition has in combination an amount of polycarbonate from 30-50 wt. % and a heat deflection temperature of at least 90° C., preferably at least 95° C.

In a particularly preferred embodiment of the invention the composition comprises
(A) from 30 to 50 wt. % of aromatic polycarbonate,
(B) from 15 to 35 wt. % of impact modifier,
(C) from 15 to 35 wt. % of flow enhancing copolymer composition,
(D) from 0 to 10 wt. % of further components
   wherein,
the combined weight of components (A), (B), (C) and (D) equals to 100 wt. % and the wt. % is based on the weight of the composition,
the impact modifier comprises or consists of graft type copolymer of acrylonitrile butadiene and styrene wherein the amount of butadiene elastomer is at least 50 wt. %, based on the weight of the copolymer,
the flow enhancing copolymer composition consists of (i) from 0 to 90 wt. % of styrene acrylonitrile copolymer and (ii) from 100 to 10 wt. % of a copolymer of α-methyl styrene, acrylonitrile and optionally styrene and having a Tg that is higher than the Tg of said styrene acrylonitrile copolymer,
   wherein the composition has a heat deflection temperature measured in accordance with the method disclosed herein of at least 90° C., preferably at least 95° C.

The preferred description of the components and properties for this composition as disclosed herein also apply to this specific composition.

The thermoplastic composition preferably has a Notched Izod Impact strength at −30° C. of at least 20 kJ/m², preferably at least 30 kJ/m², more preferably at least 40 kJ/m². In addition it is preferred that the thermoplastic composition has a ductility of at least 90% as determined in accordance with ISO180/A on injection moulded test bars having a thickness of 4 mm and provided with an A type notch. The ductility is the percentage of test bars that showed partial break as defined in said standard. The impact properties are determined on the basis of 10 test bars.

The thermoplastic composition as disclosed herein preferably has a melt volume rate of from 5 to 20 cm³/10 min, preferably 8-15 cm³/10 min as determined in accordance with ASTM D1238 (260° C., 5 kg).

In the context of the present invention it is to be understood that where it is disclosed that a composition has a certain Notched Izod Impact strength, and/or a certain ductility and/or a certain heat deflection temperature and/or a certain melt volume rate, that the composition is selected to have any one or more of said properties. Thus, the composition disclosed herein is selected to have a heat deflection temperature measured in accordance with the method disclosed herein of at least 90° C., preferably at least 95° C. and preferably is selected to have a Notched Izod Impact strength at −30° C. of at least 20 kJ/m², preferably at least 30 kJ/m², more preferably at least 40 kJ/m². In addition it is preferred that the thermoplastic composition is selected to have a ductility of at least 90% as determined in accordance with ISO180/A on injection moulded test bars having a thickness of 4 mm and provided with an A type notch. The thermoplastic composition as disclosed herein preferably is selected to have a melt volume rate of from 5 to 20 cm³/10 min, preferably 8-15 cm³/10 min as determined in accordance with ASTM D1238 (260° C., 5 kg).

The thermoplastic composition comprises three polymer components, being polycarbonate (A), impact modifier component (B) and flow enhancing copolymer composition (C). Preferably further polymer components do not exceed 15, preferably 10, more preferably 5 parts by weight per 100 parts by weight of combined components (A), (B) and (C). More preferably no further polymer components are comprised in composition.

In an aspect the composition essentially consists or consists of the components (A)-(D) as disclosed herein. For the avoidance of doubt this holds for any combination and any limitation of the said components as disclosed herein.

Preferably the composition of the present invention does not comprise a terpolymer of α-methyl-styrene, styrene and acrylonitrile. Preferably the flow enhancing composition does not comprise a terpolymer of α-methyl-styrene, styrene and acrylonitrile.

### Articles

The present invention also relates to plated articles comprising the thermoplastic composition as disclosed herein. More in particular the present invention also relates to articles shaped from the thermoplastic composition disclosed herein and wherein at least a portion of the surface of said articles is provided with a plating layer. The shaping can be performed by any method known to the skilled person including moulding techniques such as in particular injection moulding, extrusion techniques such as film or profile extrusion and foaming techniques. The plating layer can be a layer provided by means of an electro-plating process or by an electroless plating process. The present invention is not limited to a specific plating process and any method known to the skilled person can be used.

Articles having a plating layer include but are not limited to automotive articles, household appliances, consumer and professional electronics, electronic parts such as connectors, hand-held devices like tablet computers or mobile telephones, toys and articles of furniture.

In an aspect the present invention further relates to the use of α-methyl-styrene-acrylonitrile in a composition comprising polycarbonate and acrylonitrile-butadiene-styrene polymer for improving the adhesion of a plating layer provided to the surface of an article moulded from said composition by means of an electro-plating process.

In another aspect the present invention further relates to the use of a styrene-α-methyl-styrene-acrylonitrile terpolymer in a composition comprising polycarbonate and acrylonitrile-butadiene-styrene polymer for improving the adhesion of a plating layer provided to the surface of an article moulded from said composition by means of an electro-plating process.

Thus, in accordance with that aspect the present invention also relates to a thermoplastic composition comprising,
(A) from 30 to 80 wt. %, preferably 30 to 70 wt. % of aromatic polycarbonate,
(B) from 10 to 35 wt. %, preferably 15 to 35 wt. % of impact modifier,
(C) from 10 to 35 wt. %, preferably 15 to 35 wt. % of flow enhancing copolymer composition,
(D) from 0 to 10 wt. % of further components
   wherein,
the combined weight of components (A), (B), (C) and (D) equals to 100 wt. % and the wt. % is based on the weight of the composition,
the impact modifier comprises a copolymer of a conjugated diene elastomer wherein the amount of diene elastomer is at least 50 wt. %, based on the weight of the copolymer,
the flow enhancing copolymer composition consists of a styrene-α-methyl-styrene-acrylonitrile terpolymer having a Tg that is higher than the Tg of a styrene-acrylonitrile copolymer having the same molar ratio of styrene and acrylonitrile as the molar ratio of styrene and acrylonitrile in the terpolymer.

Plating

In yet a further aspect the present invention relates to a method for the manufacture of plated article comprising the steps of moulding the composition disclosed herein into an article followed by etching and plating of at least part of the surface of said article.

In the etching step at least part of the materials at or near the surface are etched away. In particular the polybutadiene rubber phase will be etched, yet the present inventors found that other components such as in particular the flow enhancing composition may also be removed at least in part. The etched surface will provide sufficient anchor points for the plating layer thereby allowing for a good adhesion of the plating layer that is applied in a later step of the plating process.

The etched surface may be activated and provided with an electroless plating layer on which one or more further layers are applied by means of an electro plating process.

The present invention is not limited with respect to the type of plating process that is applied. By way of example reference is made to EP 2807290 directed in particular at the etching process but also generally disclosing the plating process per se.

The present invention will now be further elucidated based on the following non-limiting examples.

### Test Methods

| | |
|---|---|
| Impact | Notched Izod Impact was determined in accordance |
| | with ISO180/A on injection moulded test bars having a |
| | thickness of 4 mm and provided with an A type notch. |
| | The ductility is the percentage of test bars that |
| | showed partial break as defined in said standard. The |
| | impact properties are determined on the basis of 10 |
| | test bars and the reported impact strength an average |
| | value. |
| Melt volume | The melt volume rate was determined in accordance |
| rate (MVR) | with ASTM D1238. For polycarbonate measurements |
| | were carried out at a temperature of 300° C. and a |
| | load of 1.2 kg. For the compositions of the examples |
| | measurements were carried out at a temperature of |
| | 260° C. and a load of 5.0 kg. |
| Heat deflection | The heat distortion temperature, HDT (in ° C.) was |
| temperature | determined in accordance with ISO 75 flatwise at a |
| | load of 1.8 MPa on an injection moulded sample |
| | having a thickness of 4.0 mm |
| Weight average | The weight average molecular weight of |
| molecular | polycarbonate is determined by means of GPC using |
| weight | polycarbonate standards and methylene chloride |
| | as solvent and eluent. |
| Peel strength | Peel strength was measured in accordance with the |
| | standard sethod of test for peel strength of metal on |
| | plastics ASEP TP-200 ASTM B-533. The results are |
| | typically expressed in lbf/in which can be converted |
| | into SI units, where 1 lbf = 0.113 Nm. |

### Materials

The following materials were used in the experiments.

| | |
|---|---|
| PC1 | Bisphenol A polycarbonate manufactured using an |
| | interfacial process, having a weight average molecular |
| | weight of 22,000 g/mol (PC standards) |
| PC2 | Bisphenol A polycarbonate manufactured using an |
| | interfacial process, having a weight average molecular |
| | weight of 30,000 g/mol (PC standards) |
| SAN | Styrene-Acrylonitrile copolymer (SAN) having an |
| | acrylonitrile content of 27.5 wt. % and a melt flow rate of |
| | 4.9 g/10 min as determined in accordance with ISO 1133 |
| | (230° C., 1.2 kg) |
| AMSAN | Alpha-methyl styrene-Acrylonitrile copolymer having an |
| | acrylonitrile content of 30 wt. % and a melt flow rate of 11 |
| | g/10 min as determined in accordance with ISO 1133 |
| | (230° C., 3.8 kg) |
| ABS1 | HRG-ABS. Emulsion polymerised acrylonitrile-butadiene- |
| | styrene copolymer having styrene-acrylonitrile grafts on a |
| | butadiene core, with nominal butadiene content of 50 wt. %, |
| | 11 wt. % of acrylonitrile and 39 wt. % of styrene. |
| ABS2 | HRG-ABS. Emulsion polymerized acrylonitrile-butadiene- |
| | styrene copolymer having styrene-acrylonitrile grafts on a |
| | butadiene core, with nominal butadiene content of 61 wt. %, |
| | 9 wt. % of acrylonitrile, 28 wt. % of styrene and 2 wt. % of |
| | methyl methacrylate. |
| PETS | Pentaerythritol-tetra stearate |
| STAB1 | Tris(2,4-di-t-butylphenyl)phosphite |
| STAB2 | Octadecyl 3,5-di-tert-butyl-4-hydroxyhydrocinnamate |
| STAB3 | Pentaerythritol tetrakis(3-laurylthiopropionate) |

Table 1 summarises the experiments that were carries out.

TABLE 1

| | CE1 | CE2 | E1 | E2 | CE3 |
|---|---|---|---|---|---|
| PC1 [wt. %] | 37.1 | 37.1 | 37.1 | 37.1 | 41.4 |
| PC2 [wt. %] | 12.4 | 12.4 | 12.4 | 12.4 | 13.8 |
| SAN [wt. %] | 21.9 | 25.7 | 12.9 | 0 | 19.9 |
| AMSAN [wt. %] | 0 | 0 | 12.9 | 25.7 | |
| ABS1 [wt. %] | 28 | 0 | 0 | 0 | |
| ABS2 [wt. %] | 0 | 24.1 | 24.1 | 24.1 | 24.1 |
| PETS [wt. %] | 0.15 | 0.15 | 0.15 | 0.15 | 0.15 |
| STAB1 [wt. %] | 0.1 | 0.1 | 0.1 | 0.1 | 0.1 |
| STAB2 [wt. %] | 0.3 | 0.3 | 0.3 | 0.3 | 0.3 |
| STAB3 [wt. %] | 0.2 | 0.2 | 0.2 | 0.2 | 0.2 |
| MVR [cm³/10 min] | 12.4 | 11.7 | 11 | 8.9 | 11 |
| HDT [° C.] | 94.4 | 94.6 | 97.6 | 99.3 | 99.6 |
| NII Impact Strength @ −30° C. | 33 | 45 | 40 | 33 | |
| [kJ/m²] | | | | | |
| NII Ductility [%] | 100 | 100 | 100 | 100 | |
| Blister formation | no | no | no | no | yes |
| Peel strength [lbf/in] | 4.30 | 5.37 | 5.19 | 5.24 | 5.12 |

The blister formation was evaluated by inspecting plated samples that were subjected to thermal cycling. It was observed that the examples CE1, CE2, E1 and E2 did not show blister formation upon such thermal cycling. However, the HDT of CE1 and CE2 is less preferred for certain applications. Example 5 shows that while an increased HDT is obtained by increasing the amount of polycarbonate, such higher HDT does not result in an improved plating performance and blisters were found upon thermal cycling.

The peel strength is a measure for the adhesion of the plating layer to the substrate.

1. Thermoplastic composition comprising,
(A) from 30 to 80 wt. % of aromatic polycarbonate,
(B) from 10 to 35 wt. % of impact modifier,
(C) from 10 to 35 wt. % of flow enhancing copolymer composition,
(D) from 0 to 10 wt. % of further components
wherein,
the combined weight of components (A), (B), (C) and (D) equals to 100 wt. % and the wt. % is based on the weight of the composition,
the impact modifier comprises a copolymer of a conjugated diene elastomer wherein the amount of diene elastomer is at least 50 wt. %, based on the weight of the copolymer,
the flow enhancing copolymer composition consists of (i) from 0 to 90 wt. % of first aromatic vinyl copolymer and (ii) from 100 to 10 wt. % of second aromatic vinyl copolymer having a Tg that is higher than the Tg of said first aromatic vinyl copolymer.

2. The composition of claim 1 comprising from 30 to 70 wt. % of component (A), from 15-35 wt. % of component (B) and from 15-35 wt. % of component (C).

3. The composition of claim 1 wherein the flow enhancing copolymer composition consists of (i) from 1 to 90 wt. %, 10-80 wt. %, 25-75 wt. % or 40-60 wt. % of first aromatic vinyl copolymer and (ii) from 99 to 10 wt. %, 80-10 wt. %, 75-25 wt. %, or 60-40 wt. % of second aromatic vinyl copolymer.

4. The composition of claim 1 wherein the first aromatic vinyl copolymer is a copolymer of styrene and acrylonitrile and the second aromatic vinyl copolymer is a copolymer of α-substituted styrene, and acrylonitrile.

5. The composition of claim 1 wherein the flow enhancing copolymer composition consists of 0 to 80 wt. %, of styrene-acrylonitrile copolymer and from 100 to 20 wt. % of copolymer of α-substituted-styrene, acrylonitrile and optionally styrene.

6. The composition of claim 5 wherein the α-substituted-styrene-acrylonitrile copolymer is α-methyl-styrene-acrylonitrile copolymer.

7. The composition of claim 1 wherein the copolymer comprised in the impact modifier is selected from the group consisting of styrene-butadiene-styrene (SBS), styrene-butadiene (SBR), styrene-ethylene-butadiene-styrene (SEBS), acrylonitrile-butadiene-styrene (ABS), acrylonitrile-ethylene-propylene-diene-styrene (AES), styrene-isoprene-styrene (SIS), methyl methacrylate-butadiene (MB) and methyl methacrylate-butadiene-styrene (MBS) and combinations of at least two of the foregoing copolymers.

8. The composition of claim 1 wherein the polycarbonate is a bisphenol A polycarbonate, the impact modifier is acrylonitrile-butadiene-styrene, the first aromatic vinyl copolymer is a styrene acrylonitrile copolymer and the second aromatic vinyl copolymer is a copolymer of α-methyl styrene, acrylonitrile and optionally styrene.

9. The composition of claim 1 wherein said thermoplastic composition has one or more of
a heat deflection temperature of at least 95° C. when measured in accordance with ISO 75 flatwise at a load of 1.8 MPa on an injection moulded sample having a thickness of 3.2 mm,
a melt volume rate of from melt volume rate of from 5 to 20 cm³/10 min determined in accordance with ASTM D1238 (260° C., 5 kg),
a ductility of at least 90%, wherein the ductility is the percentage of test bars that showed partial break as defined in ISO 180/A on injection moulded test bars having a thickness of 4 mm and provided with an A type notch, wherein the number of test bars is ten.

10. The composition of claim 1 wherein the composition does not comprise a terpolymer of α-methyl-styrene, styrene and acrylonitrile.

11. Moulded article comprising or consisting of the composition of claim 1.

12. Method for the manufacture of a plated article comprising providing the moulded article of claim 11 and applying a plating layer to at least a part of the surface of said article by means of a plating process.

13. The method of claim 12 comprising a step of etching at least part of the polybutadiene on or close to the surface of the moulded article.

14. Use of the composition of claim 1 for the manufacture of a plated article comprising moulding the composition into an article and applying a plating layer to at least a portion of the surface of said article by means of a plating process.

15. Use of α-methyl-styrene-acrylonitrile copolymer in a composition comprising polycarbonate and acrylonitrile-butadiene-styrene polymer for improving the adhesion of an electroplating layer provided on the surface of an article moulded from said composition.

16. The composition of claim 1, wherein the first aromatic vinyl copolymer is a copolymer of styrene and acrylonitrile and the second aromatic vinyl copolymer is a copolymer of α-substituted styrene, acrylonitrile and styrene, and wherein the α-substituted styrene is selected from α-methyl styrene, α-ethyl styrene, α-propyl styrene and α-butyl styrene.

17. The composition of claim 1, wherein the flow enhancing copolymer composition consists of 0 to 60 wt. % of styrene-acrylonitrile copolymer and from 100 to 40 wt. % of copolymer of α-substituted-styrene, acrylonitrile and styrene.

18. Method for the manufacture of a plated article comprising providing the moulded article of claim 11 and applying a plating layer to at least a part of the surface of said article by means of an electro-plating-process.

19. Use of the composition of claim 1 for the manufacture of an electro-plated article, comprising moulding the composition into an article and applying a plating layer to at least a portion of the surface of said article by means of an electro-plating process.
